(19) United States
(12) Patent Application Publication
(10) Pub. No.: US 2014/0002396 A1
(43) Pub. Date: Jan. 2, 2014

(54) INFORMATION PROCESSING METHOD, INFORMATION PROCESSING APPARATUS AND ELECTRONIC DEVICE

(71) Applicant: Lenovo (Beijing) Co., Ltd., Beijing (CN)

(72) Inventors: Qian Zhao, Beijing (CN); Qing Xu, Beijing (CN)

(21) Appl. No.: 13/930,914

(22) Filed: Jun. 28, 2013

(30) Foreign Application Priority Data
Jun. 29, 2012 (CN) 201210226755.4

(51) Int. Cl. G06F 3/041

(52) U.S. Cl. CPC G06F 3/041
USPC 345/173

(57) ABSTRACT

An information processing method, an information processing apparatus and an electronic device. The information processing method is applicable in an electronic device including at least a display unit which is able to receive a touch operation, and the method includes: acquiring touch information of an input object; and displaying a notice when the touch information indicates that the touch operation of the input object meets a predetermined condition.

### CROSS REFERENCE TO RELATED APPLICATION

This application claims the benefit of priority to Chinese Patent Application No. 201210226755.4, entitled “information processing Method, information processing apparatus and electronic device”, filed on Jun. 29, 2012 with State Intellectual Property Office of PRC, which is incorporated herein by reference in its entirety.

### FIELD OF THE INVENTION

The invention relates to the technical field of electronic device, and in particular to an information processing method, an information processing apparatus and an electronic device.

### BACKGROUND OF THE INVENTION

With the development of science and technology, various electronic products are more and more popularized and facilitate daily life of the people. The information process performed by using the electronic products is advantageous for being convenient, fast and resource-saving, and therefore the electronic products have played an indispensable role in the life or work of the people.

For the electronic devices with touch function, such as a panel computer or a touch screen mobile phone, key pressing is unnecessary and a user can operate the electronic devices using a finger, a stylus or another input object, and perfect experience is brought to the user.

However, a user who uses the electronic devices with touch function for the first time often makes some false operations, resulting in user complaint to the electronic devices. For example, after a palm rejection function of the panel computer is enabled, if the palm of the user touches the display screen when the user operates on the panel computer, a detecting element of the panel computer detects that the area of the touched region is greater than a specific area threshold, thus a processor will perform a palm rejection process directly, i.e., the touch operation of the input object on other parts of the display screen is considered as an invalid operation, and finally, the user will consider that the panel computer reacts insensitively or has a fault, and the user experience is degraded.

How to improve the user experience when the user performs a false operation on the electronic devices with touch function has become a notable problem.

### SUMMARY OF THE INVENTION

To solve the above technical problem, an information processing method, an information processing apparatus and an electronic device are provided according to embodiments of the invention, for improving the user experience when the user performs a false operation on the electronic device with touch function.

An information processing method is provided according to an embodiment of the invention, wherein the method is applicable in an electronic device including at least a display unit which is able to receive a touch operation, and the method includes:

acquiring touch information of an input object; and

displaying a notice when the touch information indicates that the touch operation of the input object meets a predetermined condition.

Preferably, the predetermined condition may be that

an area of a contact region where the input object contacts with the display unit is greater than a first threshold, wherein the first threshold may be an area threshold corresponding to an achievement of a palm rejection function.

Preferably, the displaying a notice may include:

displaying a graphic notice on the display unit, for prompting that in this touch operation the area of the contact region where the input object contacts with the display unit is too large.

Preferably, the electronic device may further include an audio output unit, and the displaying a notice may include:

outputting an audio notice, for prompting that in this touch operation the area of the contact region where the input object contacts with the display unit is too large.

Preferably, the predetermined condition may be that

a contact pressure of the input object on the display unit is less than a second threshold.

Preferably, the displaying a notice may include:

displaying a graphic notice on the display unit, for prompting that in this touch operation the contact pressure of the input object on the display unit is too small.

Preferably, the electronic device may further include an audio output unit, and the displaying a notice may include:

outputting an audio notice, for prompting that in this touch operation the contact pressure of the input object on the display unit is too small.

An information processing apparatus is further provided according to an embodiment of the invention, wherein the information processing apparatus is applicable in an electronic device including at least a display unit which is able to receive a touch operation, wherein the information processing apparatus includes:

an acquiring module, adapted to acquire touch information of an input object and send the acquired touch information to a judging module;

the judging module, adapted to judge whether the touch operation of the input object meets a predetermined condition based on the touch information, and to trigger a notice module if it is judged that the touch operation of the input object meets the predetermined condition; and

the notice module, adapted to display a notice.

Preferably, the judging module may include:

an area judging unit, adapted to judge whether the area of a contact region where the input object contacts with the display unit is greater than a first threshold based on the touch information, and to trigger the notice module if it is judged that the area of the contact region where the input object contacts with the display unit is greater than the first threshold;

wherein the first threshold may be an area threshold corresponding to an achievement of a palm rejection function.

Preferably, the notice module may include:

a first graphic notice unit, adapted to display a graphic notice on the display unit, for prompting that in this touch operation the area of the contact region where the input object contacts with the display unit is too large.

Preferably, the electronic device may further include an audio output unit, and the notice module may include:

a first audio notice unit, adapted to output an audio notice, for prompting that in this touch operation the area of the contact region where the input object contacts with the display unit is too large.

Preferably, the judging module may include:

a pressure judging unit, adapted to judge whether a contact pressure of the input object on the display unit is less than a second threshold based on the touch information, and to trigger the notice module if it is judged that the contact pressure of the input object on the display unit is less than the second threshold.

Preferably, the notice module may include:

a second graphic notice unit, adapted to display a graphic notice on the display unit, for prompting that in this touch operation the contact pressure of the input object on the display unit is too small.

Preferably, the electronic device may further include an audio output unit, and the notice module may include:

a second audio notice unit, adapted to output an audio notice, for prompting that in this touch operation the contact pressure of the input object on the display unit is too small.

An electronic device is further provided according to an embodiment of the invention, and the electronic device includes a display unit which is able to receive a touch operation and an information processing apparatus which includes:

an acquiring module, adapted to acquire touch information of an input object and send the acquired touch information to a judging module;

the judging module, adapted to judge whether the touch operation of the input object meets a predetermined condition based on the touch information, and to trigger a notice module if it is judged that the touch operation of the input object meets the predetermined condition; and

the notice module, adapted to display a notice.

As compared with the prior art, in the technical solutions according to the embodiments of the invention, when a user operates on an electronic device with touch function, the electronic device acquires the touch information of the input object, and displays a notice when the touch information indicates that the touch operation of the input object meets a predetermined condition, thereby the user experience can be improved when the user performs a false operation on the electronic device with touch function.

### BRIEF DESCRIPTION OF THE DRAWINGS

In order to illustrate the technical solutions according to the embodiments of the present invention or in the prior art more clearly, drawings to be used in the description of the prior art or the embodiments will be described briefly hereinafter. Apparently, the drawings described hereinafter are only some embodiments of the present invention, and other drawings may be obtained by those skilled in the art according to those drawings without creative labor.

FIG. 1 is a first flow chart of an information processing method according to an embodiment of the invention;

FIG. 2 a second flow chart of an information processing method according to an embodiment of the invention;

FIG. 3 a third flow chart of an information processing method according to an embodiment of the invention;

FIG. 4 a fourth flow chart of an information processing method according to an embodiment of the invention;

FIG. 5 a fifth flow chart of an information processing method according to an embodiment of the invention; and

FIG. 6 is a schematic structural diagram of an information processing apparatus according to an embodiment of the invention.

### DETAILED DESCRIPTION OF THE INVENTION

Hereinafter, the technical solutions in the embodiments of the present invention will be described clearly and completely in conjunction with the drawings in the embodiment of the present invention. Obviously, the described embodiments are only a part of the embodiments of the present invention, but not all the embodiments. All the other embodiments obtained by those skilled in the art based on the embodiment in the present invention without invention efforts will fall within the scope of protection of the present invention.

An information processing method, an information processing apparatus and an electronic device are provided according to embodiments of the invention, for improving the user experience by showing information which prompts that the current touch operation is a false operation when the user performs a false operation on the electronic device with touch function.

Hereinafter, the information processing method according to an embodiment of the invention is described at first.

It is to be noted that the information processing method is applicable in an electronic device including at least a display unit which is able to receive a touch operation. Specifically, the electronic device can be a device that is able to receive the touch operation, such as a panel computer or a mobile phone, and the display unit can be a display screen.

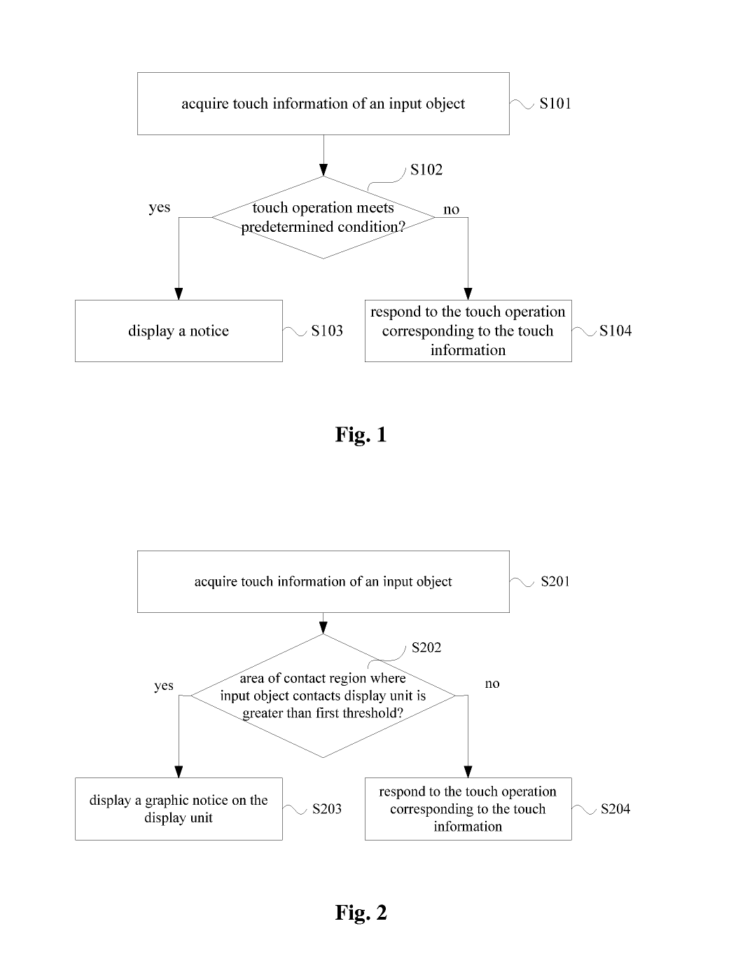

As shown in FIG. 1, an information processing method may include the following steps S107 to S104.

S101, acquiring touch information of an input object.

When a user operates on an electronic device by using an input object, the electronic device can acquire the touch information of the current input object in real time, and thus perform subsequent processes using the acquired touch information.

Specifically, the input object can be a finger, a stylus or the like, and for different false operations, the touch information to be acquired can be different. For example, for the false operation caused by the touch on the display unit by the palm, the touch information should include at least the area of a contact region where the input object contacts with the display unit; and for the false operation caused by the contact pressure of the input object on the display unit being too small, the touch information should include at least the contact pressure of the input object on the display unit or the like, each of which conditions is reasonable.

S102, judging whether the touch operation of the input object meets a predetermined condition based on the touch information, proceeding to step S103 if it is judged that the touch operation of the input object meets a predetermined condition based on the touch information; otherwise, proceeding to step S104. Specifically, the predetermined condition corresponds to the case in which the user performs the false operation on the electronic device with touch function.

After the touch information is acquired, it can be judged whether the touch operation of the input object meets the predetermined condition based on the touch information, and different operations can be performed based on different judging results. Specifically, if the touch information indicates that the touch operation of the input object meets the predetermined condition, it is indicated that the touch operation of the input object is a false operation, then step S103 needs to be performed, for performing the false operation prompt; and if the touch information indicates that the touch operation of the input object does not meet the predetermined condition, it is indicated that the touch operation of the input object is a normal operation, then step S104 needs to be performed, for responding to the touch operation corresponding to the touch information.

It can be understood that the predetermined condition can be different for different false operation. For example, for the false operation caused by the touch on the display unit by the palm, the predetermined condition can be that the area of a contact region where the input object contacts with the display unit is greater than a first threshold; and for the false operation caused by the contact pressure of the input object on the display unit being too small, the predetermined condition can be that the contact pressure of the input object on the display unit is less than a specific threshold or the like, each of which conditions is reasonable.

S103, displaying a notice.

If the acquired touch information indicates that the touch operation of the input object meets the predetermined condition, it is indicated that the touch operation of the input object is a false operation, and then a notice can be displayed, for prompting that the touch operation is a false operation. Specifically, the manner in which the notice is displayed can be a graphic prompt manner, an audio prompt manner, a graphic prompt plus audio prompt manner, or the like, each of which is reasonable.

S104, responding to the touch operation corresponding to the touch information.

If the acquired touch information indicates that the touch operation of the input object does not meet the predetermined condition, it is indicated that the touch operation of the input object is a normal operation, and then the touch operation corresponding to the touch information is responded.

As compared with the prior art, in the technical solution according to the embodiment of the invention, when a user operates on an electronic device with touch function, the electronic device acquires the touch information of the input object, and displays a notice when the touch information indicates that the touch operation of the input object meets a predetermined condition, thereby the user experience can be improved when the user performs a false operation on the electronic device with touch function.

An information processing method according to an embodiment of the invention will be described by taking the touch of the palm as an example of the false operation of the user on the electronic device with touch function.

It is to be noted that the method is applicable in an electronic device including at least a display unit which is able to receive a touch operation, and the electronic device has a palm rejection function, i.e., when it is detected that the area of a contact region where the input object contacts with the display unit is greater than a specific area, the touch operation of the input object on other parts of the display screen is considered as an invalid operation. Specifically, the electronic device can be a device that is able to receive the touch operation, such as a panel computer or a mobile phone, and the display unit can be a display screen.

As shown in FIG. 2, an information processing method may include the following steps S201 to S204.

S201, acquiring touch information of an input object.

When a user operates on an electronic device in which the palm rejection function has been enabled, the electronic device can acquire the touch information of the current input object in real time, and thus perform subsequent processes using the acquired touch information. Specifically, the input object can be a finger, a stylus or the like, each of which conditions is reasonable.

It can be understood that this embodiment is described for the case in which the false operation is the contact of a palm on the display unit, thus the touch information should include at least the area of the contact region where the input object contacts with the display unit.

S202, judging whether the area of a contact region where the input object contacts with the display unit is greater than a first threshold based on the touch information.

Specifically, the first threshold is an area threshold corresponding to the achievement of the palm rejection function. The user can perform at least one touch operation on at least one point of the display unit using at least one input object at the same time, thus the electronic device can acquire a contact region consisting of at least one region, and if the display unit is touched by a palm, the region in which the palm contacts with the display unit will be contained in the acquired contact region.

After the touch information is acquired, it can be judged whether the area of a contact region where the input object contacts with the display unit is greater than a first threshold based on the touch information, and different operations can be performed based on different judging results. Specifically, if the touch information indicates that the area of the contact region where the input object contacts with the display unit is greater than the first threshold, it is indicated that the touch operation contains the touch of the palm, then step S203 needs to be performed, for prompting the false operation; and if the touch information indicates that the area of the contact region where the input object contacts with the display unit is not greater than the first threshold, it is indicated that the touch operation of the input object is a normal operation, then step S204 needs to be performed, for responding to the touch operation corresponding to the touch information.

S203, displaying a graphic notice on the display unit, for prompting that in this touch operation the area of the contact region where the input object contacts with the display unit is too large.

If the acquired touch information indicates that the area of the contact region where the input object contacts with the display unit is greater than the first threshold, it is indicated that the touch operation is a false operation, i.e., containing the touch of the palm, and then a graphic notice can be displayed on the display unit, for prompting that in this touch operation the area of the contact region where the input object contacts with the display unit is too large. For example, the graphic notice can be information indicating that the use of palm is not allowed or other graphic message, each of which is reasonable.

S204, responding to the touch operation corresponding to the touch information.

If the acquired touch information indicates that the area of the contact region where the input object contacts with the display unit is not greater than the first threshold, it is indicated that the touch operation of the input object is a normal operation, and then the touch operation corresponding to the touch information is responded to.

In this embodiment, when a user operates on an electronic device with touch function and the palm rejection function of the electronic device is enabled, the electronic device acquires the touch information of the input object, and displays a graphic notice on the display unit when the touch information indicates that the area of the contact region where the input object contacts with the display unit is greater than the first threshold, for prompting that in this touch operation the area of the contact region where the input object contacts with the display unit is too large, thereby the user experience can be improved when the user performs a false operation on the electronic device with touch function due to the touch of the palm.

Another method for processing information according to an embodiment of the invention will be described by taking the touch of the palm as an example of the false operation of the user on the electronic device with touch function.

It is to be noted that the method is applicable in an electronic device including at least a display unit which is able to receive a touch operation and an audio output unit. Specifically, the electronic device has a palm rejection function, i.e., when it is detected that the area of the contact region where the input object contacts with the display unit is greater than a specific area, the touch operation of the input object on other parts of the display screen is considered as an invalid operation. Specifically, the electronic device can be a device that is able to receive the touch operation, such as a panel computer or a mobile phone, and the display unit can be a display screen.

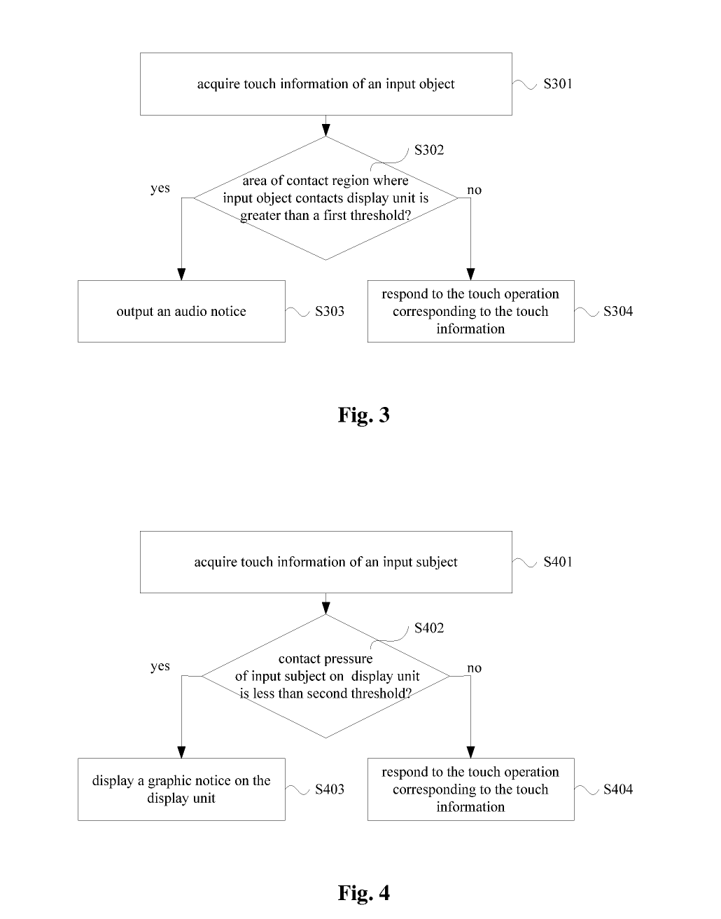

As shown in FIG. 3, an information processing method may include the following steps S301 to S304.

S301, acquiring touch information of an input object.

S302, judging whether the area of a contact region where the input object contacts with the display unit is greater than a first threshold based on the touch information.

Specifically, the first threshold is an area threshold corresponding to the achievement of the palm rejection function.

Steps S301 to S302 in this embodiment are similar to steps S201 to S202 in the above embodiment respectively, which will not be described in detail here.

S303, outputting an audio notice, for prompting that in this touch operation the area of the contact region where the input object contacts with the display unit is too large.

If the acquired touch information indicates that the area of the contact region where the input object contacts with the display unit is greater than the first threshold, it is indicated that the touch operation is a false operation, i.e., containing the touch of the palm, and then an audio notice can be output, for prompting that in this touch operation the area of the contact region where the input object contacts with the display unit is too large.

S304, responding to the touch operation corresponding to the touch information.

If the acquired touch information indicates that the area of the contact region where the input object contacts with the display unit is not greater than the first threshold, it is indicated that the touch operation of the input object is a normal operation, and then the touch operation corresponding to the touch information is responded to.

In this embodiment, when a user operates on an electronic device with touch function and the palm rejection function of the electronic device is enabled, the electronic device acquires the touch information of the input object, and outputs an audio notice when the touch information indicates that the area of the contact region where the input object contacts with the display unit is greater than the first threshold, for prompting that in this touch operation the area of the contact region where the input object contacts with the display unit is too large, thereby the user experience can be improved when the user performs a false operation on the electronic device with touch function due to the touch of the palm.

Yet another method for processing information according to an embodiment of the invention will be described by taking the false operation caused by the contact pressure of the input object on the display unit being too small as an example.

It is to be noted that the method is applicable in an electronic device including at least a display unit which is able to receive a touch operation. Specifically, the electronic device can be a device which is able to receive a touch operation, such as a panel computer or a mobile phone, and the display unit can be a display screen.

As shown in FIG. 4, an information processing method may include the following steps S401 to S404.

S401, acquiring touch information of an input object.

When a user operates on the electronic device, the electronic device can acquire the touch information of the input object in real time, and thus perform subsequent processes using the acquired touch information. Specifically, the input object can be a finger, a stylus or the like, each of which conditions is reasonable.

It can be understood that the false operation in this embodiment is caused by the contact pressure of the input object on the display unit being too small, thus the touch information should include at least the contact pressure of the input object on the display unit. Specifically, the contact pressure can be detected by a specific pressure detecting unit.

S402, judging whether contact pressure of the input object on the display unit is less than a second threshold based on the touch information, proceeding to a step S403 if it is judged that the contact pressure of the input object on the display unit is greater than the second threshold; otherwise, proceeding to a step S404.

After the touch information is acquired, it can be judged whether contact pressure of the input object on the display unit is less than a second threshold based on the touch information, and different operations can be performed based on different judging results. Specifically, if the touch information indicates that the contact pressure of the input object on the display unit is less than the second threshold, it is indicated that the touch operation of the input object is a false operation, then step S403 needs to be performed, for performing the false operation prompt; and if the touch information indicates that the contact pressure of the input object on the display unit is not less than the second threshold, it is indicated that the touch operation of the input object is a normal operation, then step S404 needs to be performed, for responding to the touch operation corresponding to the touch information.

It can be understood that the second threshold can be determined based on the pressure required by the electronic device to respond to the touch operation of the input object.

S403, displaying a graphic notice on the display unit, for prompting that in this touch operation the contact pressure of the input object on the display unit is too small.

If the acquired touch information indicates that the touch information indicates that the contact pressure of the input object on the display unit is less than the second threshold, it is indicated that the touch operation of the input object is a false operation, then a graphic notice can be displayed on the display unit, for prompting that in this touch operation the contact pressure of the input object on the display unit is too small.

S404, responding to the touch operation corresponding to the touch information.

If the acquired touch information indicates that the contact pressure of the input object on the display unit is not less than the second threshold, it is indicated that the touch operation of the input object is a normal operation, and then the touch operation corresponding to the touch information is responded to.

In this embodiment, when the user operates on the electronic device with touch function, the electronic device acquires the touch information of the input object, and displays a graphic notice on the display unit if the touch information indicates that the contact pressure of the input object on the display unit is less than the second threshold, for prompting that in this touch operation the contact pressure of the input object on the display unit is too small, thereby the user experience can be improved when the user performs a false operation on the electronic device with touch function caused by the contact pressure being too small.

A method for processing information according to a further embodiment of the invention will be described by taking the false operation caused by the contact pressure of the input object on the display unit being too small as an example.

It is to be noted that the method is applicable in an electronic device including at least a display unit which is able to receive a touch operation and an audio output unit. Specifically, the electronic device can be a device which is able to receive a touch operation, such as a panel computer or a mobile phone, and the display unit can be a display screen.

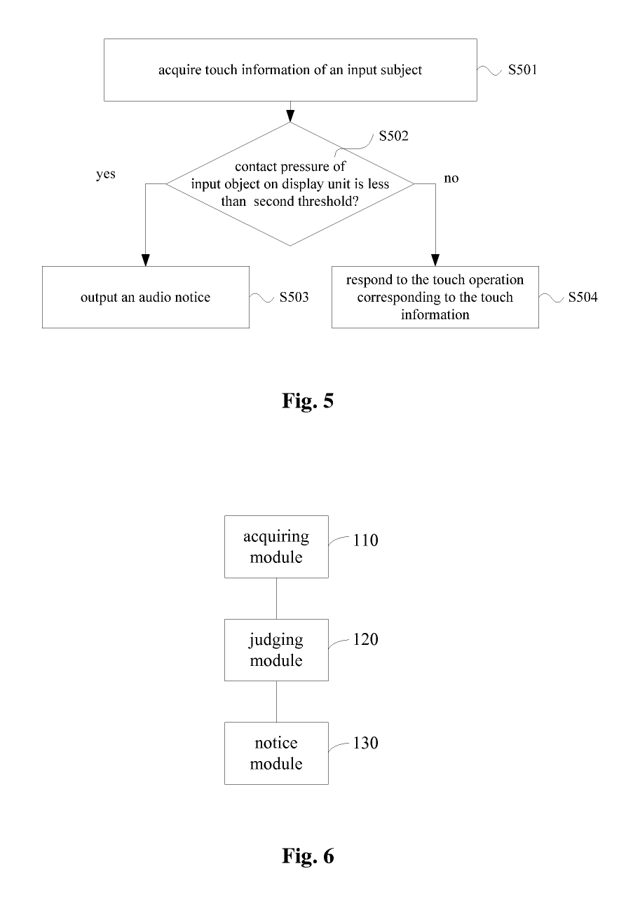

As shown in FIG. 5, an information processing method may include the following steps S501 to S504.

S501, acquiring touch information of an input object.

S502, judging whether contact pressure of the input object on the display unit is less than a second threshold, based on the touch information, proceeding to a step S503 if it is judged that the contact pressure of the input object on the display unit is greater than the second threshold; otherwise, proceeding to a step S504.

Steps S501 to S502 in this embodiment are similar to steps S401 to S402 in the above embodiment respectively, which will not be described in detail here.

S503, outputting an audio notice, for prompting that in this touch operation the contact pressure of the input object on the display unit is too small.

If the acquired touch information indicates that the touch information indicates that the contact pressure of the input object on the display unit is less than the second threshold, it is indicated that the touch operation of the input object is a false operation, then an audio notice is output, for prompting that in this touch operation the contact pressure of the input object on the display unit is too small.

S504, responding to the touch operation corresponding to the touch information.

If the acquired touch information indicates that the contact pressure of the input object on the display unit is not less than the second threshold, it is indicated that the touch operation of the input object is a normal operation, and then the touch operation corresponding to the touch information is responded to.

In this embodiment, when the user operates on the electronic device with touch function, the electronic device acquires the touch information of the input object, and outputs an audio notice if the touch information indicates that the contact pressure of the input object on the display unit is less than the second threshold, for prompting that in this touch operation the contact pressure of the input object on the display unit is too small, thereby the user experience can be improved when the user performs a false operation on the electronic device with touch function caused by the contact pressure being too small.

With the description of the above embodiment of the method, it can be understood clearly by those skilled in the art that the invention can be implemented by software plus a necessary hardware platform, and can also be implemented by hardware, with the former being better in most cases. Based on such understanding, the technical solutions of the invention or some of the technical solutions of the invention that contributes to the prior art can essentially be embodied in the form of a software product which is stored in a storage medium and includes several instructions for enabling a computer device (which can be a personal computer, a server, a net device or the like) to perform all or some of the steps of the method according to the embodiment of the invention. The storage medium includes various mediums that can store program codes, such as a Read-Only Memory (ROM), a Random Access Memory (RAM), a diskette or optical disk.

Corresponding to the above embodiments of the method, an information processing apparatus is further provided according to an embodiment of the invention, wherein the apparatus is applicable in an electronic device including at least a display unit which is able to receive a touch operation; as shown in FIG. 6, the information processing apparatus may include:

an acquiring module 110, adapted to acquire touch information of an input object and send the acquired touch information to a judging module;

the judging module 120, adapted to judge whether the touch operation of the input object meets a predetermined condition based on the touch information, and to trigger a notice module if it is judged that the touch operation of the input object meets the predetermined condition; and

the notice module 130, adapted to display a notice.

As compared with the prior art, in the technical solution according to the embodiment of the invention, when a user operates on an electronic device with touch function, the information processing apparatus in the electronic device acquires the touch information of the input object, and a notice will be displayed when the touch information indicates that the touch operation of the input object meets a predetermined condition, thereby the user experience can be improved when the user performs a false operation on the electronic device with touch function.

Specifically, the judging module 120 may include:

an area judging unit, adapted to judge whether the area of a contact region where the input object contacts with the display unit is greater than a first threshold, based on the touch information, and to trigger the notice module if it is judged that the area of the contact region where the input object contacts with the display unit is greater than the first threshold; wherein the first threshold is an area threshold corresponding to the achievement of a palm rejection function.

Accordingly, the notice module 130 may include:

a first graphic notice unit, adapted to display a graphic notice on the display unit, for prompting that in this touch operation the area of the contact region where the input object contacts with the display unit is too large.

Accordingly, the applicable electronic device may further include an audio output unit, and the notice module 130 may include:

a first audio notice unit, adapted to output an audio notice, for prompting that in this touch operation the area of the contact region where the input object contacts with the display unit is too large.

Specifically, the judging module 120 may include:

a pressure judging unit, adapted to judge whether contact pressure of the input object on the display unit is less than a second threshold based on the touch information, and to trigger the notice module if it is judged that the contact pressure of the input object on the display unit is less than the second threshold.

Accordingly, the notice module 130 may include:

a second graphic notice unit, adapted to display a graphic notice on the display unit, for prompting that in this touch operation the contact pressure of the input object on the display unit is too small.

Accordingly, the electronic device may further include an audio output unit, and the notice module 130 may include:

a second audio notice unit, adapted to output an audio notice, for prompting that in this touch operation the contact pressure of the input object on the display unit is too small.

An electronic device is further provided according to an embodiment of the invention, and the electronic device includes a display unit which is able to receive a touch operation and an information processing apparatus which may include:

an acquiring module, adapted to acquire touch information of an input object and send the acquired touch information to a judging module;

the judging module, adapted to judge whether the touch operation of the input object meets a predetermined condition based on the touch information, and to trigger a notice module if it is judged that the touch operation of the input object meets the predetermined condition; and

the notice module, adapted to display a notice.

As compared with the prior art, in the technical solution according to the embodiment of the invention, when a user operates on an electronic device with touch function, the electronic device acquires the touch information of the input object, and displays a notice when the touch information indicates that the touch operation of the input object meets a predetermined condition, thereby the user experience can be improved when the user performs a false operation on the electronic device with touch function.

Specifically, the judging module may include:

an area judging unit, adapted to judge whether the area of a contact region where the input object contacts with the display unit is greater than a first threshold based on the touch information, and to trigger the notice module if it is judged that the area of the contact region where the input object contacts with the display unit is greater than the first threshold.

Specifically, the first threshold is an area threshold corresponding to the achievement of a palm rejection function.

Accordingly, the notice module may include:

a first graphic notice unit, adapted to display a graphic notice on the display unit, for prompting that in this touch operation the area of the contact region where the input object contacts with the display unit is too large.

Accordingly, the applicable electronic device may further include an audio output unit, and the notice module may include:

a first audio notice unit, adapted to output an audio notice, for prompting that in this touch operation the area of the contact region where the input object contacts with the display unit is too large.

Specifically, the judging module may include:

a pressure judging unit, adapted to judge whether contact pressure of the input object on the display unit is less than a second threshold based on the touch information, and to trigger the notice module if it is judged that the contact pressure of the input object on the display unit is less than the second threshold.

Accordingly, the notice module may include:

a second graphic notice unit, adapted to display a graphic notice on the display unit, for prompting that in this touch operation the contact pressure of the input object on the display unit is too small.

Accordingly, the electronic device may further include an audio output unit, and the notice module may include:

a second audio notice unit, adapted to output an audio notice, for prompting that in this touch operation the contact pressure of the input object on the display unit is too small.

The embodiment of the apparatus or the system corresponds to the embodiment of the method substantially, so that reference can be made to the description of the embodiment of the method for related portions. The embodiments of the apparatus or the system described above are only illustrative, in which the unit described as a separate component can be or be not a physically separated unit, the component shown as a unit can be or be not a physical unit, i.e., can be located in one position, or be distributed onto multiple units of a network. Some or all of the modules can be chosen to implement the solutions of the embodiments according to the requirement in practice. The invention can be understood and embodied by those skilled in the art without inventive efforts.

It should be understood that the system, apparatus and method disclosed in the embodiments according to the invention can be implemented in other manners without deviating from the spirit and scope of this application. These embodiments are only illustrative, and should not be interpreted as limits, and the specific contents set forth herein should not be interpreted as to limit this invention. For example, the division into the units or sub-units is only a division in logical function, and other divisions are also possible in practice. For example, multiple units or sub-units can be combined. Further, multiple units or components can be combined or integrated into another system, or some features can be omitted or not performed.

Further, the system, apparatus and method and the schematic diagrams of the embodiments can be combined or integrated with other system, module, technique or method without deviating from the scope of this application. And the mutual coupling, direct coupling or communication connection shown or discussed can be an indirect coupling or communication connection between devices or units implemented through some interfaces, and can also be in other forms such as electrical connection or mechanical connection.

The above are only specific embodiments of the invention. It should be noted that several modifications and variations can be made by those skilled in the art without deviating from the principle of the invention, which should also be considered as within the scope of protection of the invention.

1. An information processing method, wherein the method is applicable in an electronic device comprising at least a display unit which is able to receive a touch operation, the method comprises:
acquiring touch information of an input object; and
displaying a notice when the touch information indicates that the touch operation of the input object meets a predetermined condition.

2. The method according to claim 1, wherein the predetermined condition is that the area of a contact region where the input object contacts with the display unit is greater than a first threshold, wherein the first threshold is an area threshold corresponding to an achievement of a palm rejection function.

3. The method according to claim 2, wherein the displaying a notice comprises:
displaying a graphic notice on the display unit, for prompting that in this touch operation the area of the contact region where the input object contacts with the display unit is too large.

4. The method according to claim 2, wherein the electronic device further comprises an audio output unit, and the displaying a notice comprises:
outputting an audio notice, for prompting that in this touch operation the area of the contact region where the input object contacts with the display unit is too large.

5. The method according to claim 1, wherein the predetermined condition is that a contact pressure of the input object on the display unit is less than a second threshold.

6. The method according to claim 5, wherein the displaying a notice comprises:
displaying a graphic notice on the display unit, for prompting that in this touch operation the contact pressure of the input object on the display unit is too small.

7. The method according to claim 5, wherein the electronic device further comprises an audio output unit, and the displaying a notice comprises:
outputting an audio notice, for prompting that in this touch operation the contact pressure of the input object on the display unit is too small.

8. An information processing apparatus, wherein the apparatus is applicable in an electronic device comprising at least a display unit which is able to receive a touch operation, wherein the information processing apparatus comprises:
an acquiring module, adapted to acquire touch information of an input object and send the acquired touch information to a judging module;
the judging module, adapted to judge whether the touch operation of the input object meets a predetermined condition, based on the touch information, and to trigger a notice module if it is judged that the touch operation of the input object meets the predetermined condition; and
the notice module, adapted to display a notice.

9. The information processing apparatus according to claim 8, wherein the judging module comprises:
an area judging unit, adapted to judge whether the area of a contact region where the input object contacts with the display unit is greater than a first threshold based on the touch information, and to trigger the notice module if it is judged that the area of the contact region where the input object contacts with the display unit is greater than the first threshold;
wherein the first threshold is an area threshold corresponding to an achievement of a palm rejection function.

10. The information processing apparatus according to claim 9, wherein the notice module comprises:
a first graphic notice unit, adapted to display a graphic notice on the display unit, for prompting that in this touch operation the area of the contact region where the input object contacts with the display unit is too large.

11. The information processing apparatus according to claim 9, wherein the electronic device further comprises an audio output unit, and the notice module comprises:
a first audio notice unit, adapted to output an audio notice, for prompting that in this touch operation the area of the contact region where the input object contacts with the display unit is too large.

12. The information processing apparatus according to claim 8, wherein the judging module comprises:
a pressure judging unit, adapted to judge whether a contact pressure of the input object on the display unit is less than a second threshold, based on the touch information, and to trigger the notice module if it is judged that the contact pressure of the input object on the display unit is less than the second threshold.

13. The information processing apparatus according to claim 12, wherein the notice module comprises:
a second graphic notice unit, adapted to display a graphic notice on the display unit, for prompting that in this touch operation the contact pressure of the input object on the display unit is too small.

14. The information processing apparatus according to claim 12, wherein the electronic device further comprises an audio output unit, and the notice module comprises:
a second audio notice unit, adapted to output an audio notice, for prompting that in this touch operation the contact pressure of the input object on the display unit is too small.

15. An electronic device, comprising a display unit which is able to receive a touch operation and an information processing apparatus which comprises:
an acquiring module, adapted to acquire touch information of an input object and send the acquired touch information to a judging module;
the judging module, adapted to judge whether the touch operation of the input object meets a predetermined condition based on the touch information, and to trigger a notice module if it is judged that the touch operation of the input object meets the predetermined condition; and
the notice module, adapted to display a notice.
